(19) United States
(12) Patent Application Publication
(10) Pub. No.: US 2016/0252429 A1
(43) Pub. Date: Sep. 1, 2016

(54) PRESSURE MEASUREMENT SYSTEM FOR ENGINE

(71) Applicant: Caterpillar Inc., Peoria, IL (US)

(72) Inventors: Mary Louise Yeager, Lafayette, IN (US); Alasdair Owen Lee, Schwetzingen (DE); James David Siegle, Washington, IL (US)

(73) Assignee: Caterpillar Inc., Peoria, IL (US)

(21) Appl. No.: 15/149,260

(22) Filed: May 9, 2016

(51) Int. Cl. G01M 15/05; G01M 15/06; G01M 15/08; F02D 35/02

(52) U.S. Cl. CPC G01M 15/05; F02D 35/022; F02D 35/023; F02D 35/028; G01M 15/06; G01M 15/08

(57) ABSTRACT

A pressure measurement system for an engine is illustrated. The pressure measurement system includes a pressure sensor configured to generate a signal indicative of a pressure within a cylinder and an angle sensor configured to generate a signal indicative of an angular position of a crankshaft of the engine. The pressure measurement system further includes a controller coupled to the pressure sensor and the angle sensor. The controller is configured to determine a volume of the cylinder based on the signal indicative of the angular position of the crankshaft. The controller is configured to determine a first pressure offset during a compression stroke of the engine and a second pressure offset during an expansion stroke of the engine. The controller is further configured to determine a corrected pressure value by any one of the first pressure offset and the second pressure offset based on the angular position of the crankshaft.

### TECHNICAL FIELD

The present disclosure relates to a pressure measurement system for an engine. More particularly, the present disclosure relates to the pressure measurement system for measuring pressure within one or more cylinders of the engine.

### BACKGROUND

Engines employ pressure sensors to measure real time pressure and combustion information related to cylinders of the engine. The measured information is further used by engine performance and/or diagnostic strategies to determine engine working conditions, control engine parameters, optimize engine working conditions, and so on.

The pressure sensors currently used may be affected by various factors such as temperature, pressure, humidity, age, history of operation, and so on. Such factors may alter the measured information resulting in incorrect values being used by the performance and/or diagnostic strategies in turn leading to incorrect strategies, reduced engine efficiency, reduced engine life, increased emissions, and so on. One of the factors affecting the pressure sensors is cyclic heating and/or cooling of the pressure sensors due to the combustion within the cylinders leading to thermal shock, Due to the thermal shock, artificial stress is induced on the pressure sensors. This induced stress may alter the pressure sensors' measured output resulting in incorrect data processing.

U.S. Pat. No. 7,974,762 describes a method for automatic heat release computation in a piston engine. The method includes measuring a cylinder pressure as a function of a crank angle. The method includes calculating a first polytropic exponent for a compression stroke based on the measured cylinder pressure. The method includes calculating a second polytropic exponent for an expansion stroke based on the measured cylinder pressure. The method also includes performing an interpolation of the first and second polytropic exponents for a crank angle interval between the compression stroke and the expansion stroke. The method further includes performing a net heat release computation based on the interpolated polytropic exponent.

Currently used systems and methods to compensate for the incorrect output of the pressure sensors are complex and inaccurate and may target improving only some algorithms. Hence, there is a need for an improved pressure measurement system for the engine.

### SUMMARY OF THE DISCLOSURE

In an aspect of the present disclosure, a pressure measurement system for an engine is illustrated. The pressure measurement system includes a pressure sensor coupled to a cylinder of the engine. The pressure sensor is configured to generate a signal indicative of a pressure within the cylinder. The pressure measurement system also includes an angle sensor coupled to a crankshaft of the engine. The angle sensor is configured to generate a signal indicative of an angular position of the crankshaft of the engine. The pressure measurement system further includes a controller coupled to the pressure sensor and the angle sensor. The controller is configured to receive the signal indicative of the pressure within the cylinder. The controller is configured to receive the signal indicative of the angular position of the crankshaft. The controller is configured to determine a volume of the cylinder based on the signal indicative of the angular position of the crankshaft. The controller is configured to determine a first pressure offset during a compression stroke of the engine. The controller is also configured to determine a second pressure offset during an expansion stroke of the engine. The controller is further configured to determine a corrected pressure value by any one of the first pressure offset and the second pressure offset based on the angular position of the crankshaft.

Other features and aspects of this disclosure will be apparent from the following description and the accompanying drawings.

### BRIEF DESCRIPTION OF THE DRAWINGS

FIG. 1 is a perspective view of an exemplary engine, according to one embodiment of the present disclosure;

FIG. 2 is a schematic representation of a pressure measurement system for the engine of FIG. 1, according to one embodiment of the present disclosure;

FIG. 3 is a graph showing a plot of pressure offset against crankshaft angle, according to one embodiment of the present disclosure;

FIG. 4 is a flowchart illustrating a method of working of a controller of the pressure measurement system of FIG. 2, according to one embodiment of the present disclosure; and

FIG. 5 is a flowchart illustrating a method of working of the pressure measurement system of FIG. 2, according to one embodiment of the present disclosure.

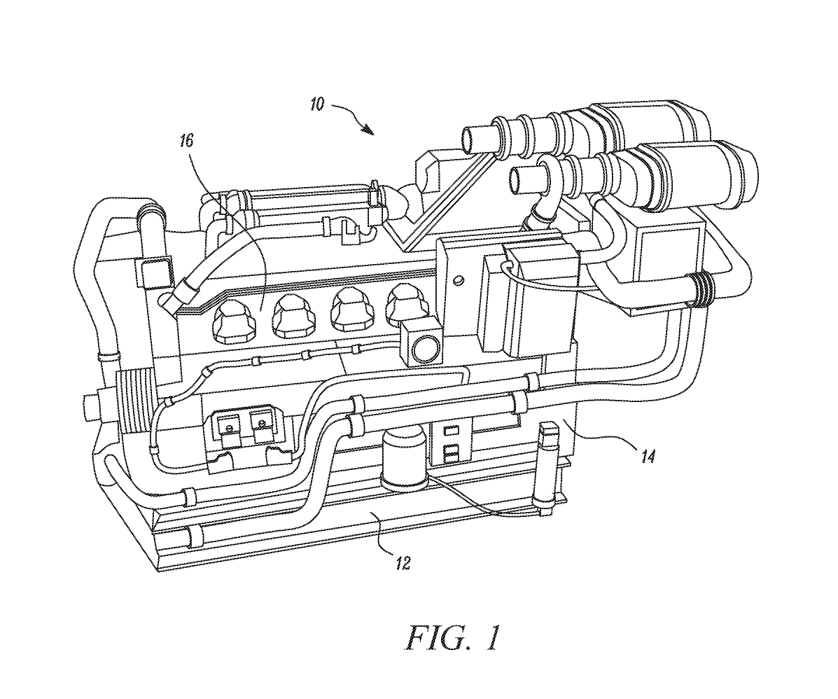

### DETAILED DESCRIPTION

Wherever possible, the same reference numbers will be used throughout the drawings to refer to the same or the like parts. Referring to FIG. 1, an exemplary engine 10 is illustrated. The engine 10 is an internal combustion engine powered by a fuel such as gasoline, diesel, natural gas, and so on, or a combination thereof. The engine 10 may be used for applications including, but not limited to, power generation, transportation, construction, agriculture, forestry, aviation, marine, material handling, and waste management.

The engine 10 includes a frame 12. The frame 12 is configured to support various components of the engine 10 such as an engine block 14 and a cylinder head 16. The frame 12 is also configured to support various components of the engine 10 (not shown) such as a crankcase, a fuel delivery system, an air system, a cooling system, peripheries, a turbocharger, an exhaust gas recirculation system, an exhaust aftertreatment system, and so on. Also, the engine 10 may be of any size including a number of cylinders (not shown) arranged in any configuration such as inline, radial, “V”, and so on.

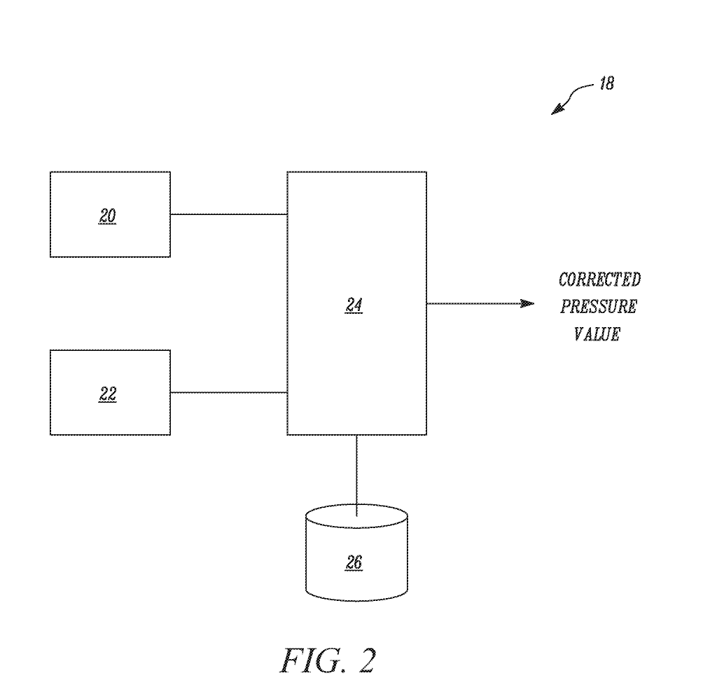

Referring to FIG. 2, a schematic representation of a pressure measurement system 18 for the engine 10 is illustrated. The pressure measurement system 18 includes a pressure sensor 20 associated with the engine 10. More specifically, the pressure sensor 20 is coupled to a cylinder of the engine 10. The pressure sensor 20 is configured to generate a signal indicative of a pressure within the cylinder of the engine 10. The pressure sensor 20 may be any pressure sensor known in the art such as a piezoelectric type pressure sensor, a strain gauge type pressure sensor, an electromagnetic type pressure sensor, an optical type pressure sensor, and so on.

The pressure measurement system 18 also includes an angle sensor 22 associated with the engine 10. More specifically, the angle sensor 22 is coupled to a crankshaft of the engine 10. The angle sensor 22 is configured to generate a signal indicative of an angular position of the crankshaft. In other embodiments, the angle sensor 22 may be coupled to a camshaft of the engine 10. Accordingly, the angle sensor 22 may be configured to generate a signal indicative of an angular position of the camshaft. The angle sensor 22 may be any angle sensor known in the art such as a hall effect type angle sensor, an optical type angle sensor, an inductive type angle sensor, and so on.

The pressure measurement system 18 further includes a controller 24. The controller 24 is coupled to the pressure sensor 20 and the angle sensor 22. The controller 24 is configured to receive the signal indicative of the pressure within the cylinder from the pressure sensor 20. Also, the controller 24 is configured to receive the signal indicative of the angular position of the crankshaft from the angle sensor 22.

Based on the received signal indicative of the angular position of the crankshaft, the controller 24 is configured to determine a volume of the cylinder. In other embodiments, the controller 24 may be configured to determine the volume of the cylinder based on the angular position of the camshaft based on application requirements. For example, based on the angular position of the crankshaft, the controller 24 may be configured to determine a position of a piston (not shown) within the cylinder. Based on the determined position of the piston within the cylinder, the controller 24 may be configured to determine the volume of the cylinder.

In one embodiment, the controller 24 may determine the volume of the cylinder based on a correlation. The correlation may be a mathematical expression between the angular position of the crankshaft, the position of the piston, and the volume of the cylinder. In other embodiments, the controller 24 may determine the volume of the cylinder based on a dataset stored in a memory (not shown) of the controller 24 or a database 26 coupled to the controller 24. The dataset may include values of the volume of the cylinder for different angular positions of the crankshaft and different positions of the piston.

Based on the received pressure signal and the determined volume of the cylinder, the controller 24 is configured to determine a first pressure offset. The first pressure offset is determined by the controller 24 during a compression stroke of the engine 10. The controller 24 is configured to determine the pressure and volume within the cylinder during the compression stroke for two different angles of the crankshaft or two different positions of the piston.

For example, the controller 24 may receive a signal indicative of a first pressure P1 within the cylinder from the pressure sensor 20 during the compression stroke. The first pressure P1 is the pressure within the cylinder after an intake valve (not shown) of the cylinder has closed and before the compression stroke has started. Also, the controller 24 is configured to determine a first volume V1 of the cylinder When the pressure within the cylinder is the first pressure P1. The controller 24 determines the first volume V1 within the cylinder based on the signal received from the angle sensor 22 when the pressure within the cylinder is the first pressure P1.

Further, the controller 24 may receive a signal indicative of a second pressure P2 within the cylinder from the pressure sensor 20 during the compression stroke. The second pressure P2 is the pressure within the cylinder after the compression stroke has ended and before start of a combustion process of a charge received within the cylinder. Also, the controller 24 is configured to determine a second volume V2 of the cylinder when the pressure within the cylinder is the second pressure P2. The controller 24 determines the second volume V2 within the cylinder based on the signal received from the angle sensor 22 when the pressure within the cylinder is the second pressure P2.

Based on the first pressure P1, the first volume V1, the second pressure P2, and the second volume V2, the controller 24 is configured to determine the first pressure offset. For example, the compression stroke follows a polytropic thermodynamic process which obeys the law (P*V^{N}=C), where P represents cylinder pressure, V represents cylinder volume, N is a real number representing a polytropic index or polytropic coefficient value, and C is the polytropic constant, Accordingly, based on the equation (P1*V1^{Ncomp})=(P2*V2^{Vcomp}), the first pressure offset is determined by the controller 24. In other embodiments, the first pressure offset may be determined by any method, law, and/or equation known in the art and may not limit the scope of the disclosure.

Additionally, based on the received pressure signal and the determined volume of the cylinder, the controller 24 is configured to determine a second pressure offset. The second pressure offset is determined by the controller 24 during an expansion stroke of the engine 10. The controller 24 is configured to determine the pressure and volume within the cylinder during the expansion stroke for two different angles of the crankshaft or two different positions of the piston.

For example, the controller 24 may receive a signal indicative of a third pressure P3 within the cylinder from the pressure sensor 20 during the expansion stroke. The third pressure P3 is the pressure within the cylinder after the combustion of the charge has occurred. Also, the controller 24 is configured to determine a third volume V3 of the cylinder when the pressure within the cylinder is the third pressure P3. The controller 24 determines the third volume V3 within the cylinder based on the signal received from the angle sensor 22 when the pressure within the cylinder is the third pressure P3.

Further, the controller 24 may receive a signal indicative of a fourth pressure P4 within the cylinder from the pressure sensor 20 during the expansion stroke. The fourth pressure P4 is the pressure within the cylinder after the expansion stroke has ended and before the exhaust valve has opened. Also, the controller 24 is configured to determine a fourth volume V4 of the cylinder when the pressure within the cylinder is the fourth pressure P4, The controller 24 determines the fourth volume V4 within the cylinder based on the signal received from the angle sensor 22 when the pressure within the cylinder is the fourth pressure P4.

Based on the third pressure P3, the third volume V3, the fourth pressure P4, and the fourth volume V4, the controller 24 is configured to determine the second pressure offset. For example, the expansion stroke follows the polytropic thermodynamic process which obeys the law (P*V^{N}=C). Accordingly, based on the equation (P3*V3^{Nexh})=(P4*V4^{Nexh}), the second pressure offset is determined by the controller 24. In other embodiments, the second pressure offset may he determined by any method, law, and/or equation known in the art and may not limit the scope of the disclosure.

It should be noted that the controller 24 may be configured to vary sampling location for the first pressure P1, the second pressure P2, the third pressure P3, the fourth pressure P4, and/or the first volume V1, the second volume V2, the third volume V3, the fourth volume V4 based on application requirements. For example, the first pressure P1, the second pressure P2, the first volume V1, and/or the second volume V2 may relate to any angular position of the crankshaft or position of the piston during the compression stroke of the engine 10. Also, the third pressure P3, the fourth pressure P4, the third volume V3, and/or the fourth volume V4 may relate to any angular position of the crankshaft or position of the piston during the expansion stroke of the engine 10. In some embodiments, the sampling location may be varied based on engine operating conditions including, but not limited to, engine speed, engine load, fuel composition, operator specified engine settings, active diagnostics/events, ambient conditions such as temperature, pressure, humidity, and so on.

The controller 24 is further configured to determine a corrected pressure value by any one of the first pressure offset and the second pressure offset based on the angular position of the crankshaft. More specifically, during the compression stroke of the engine 10, the controller 24 determines the corrected pressure value using the first pressure offset. Also, during the expansion stroke of the engine 10, the controller 24 determines the corrected pressure value using the second pressure offset. The controller 24 may determine a stroke of the engine 10, such as the compression stroke or the expansion stroke, based on the signal received from the angle sensor 22.

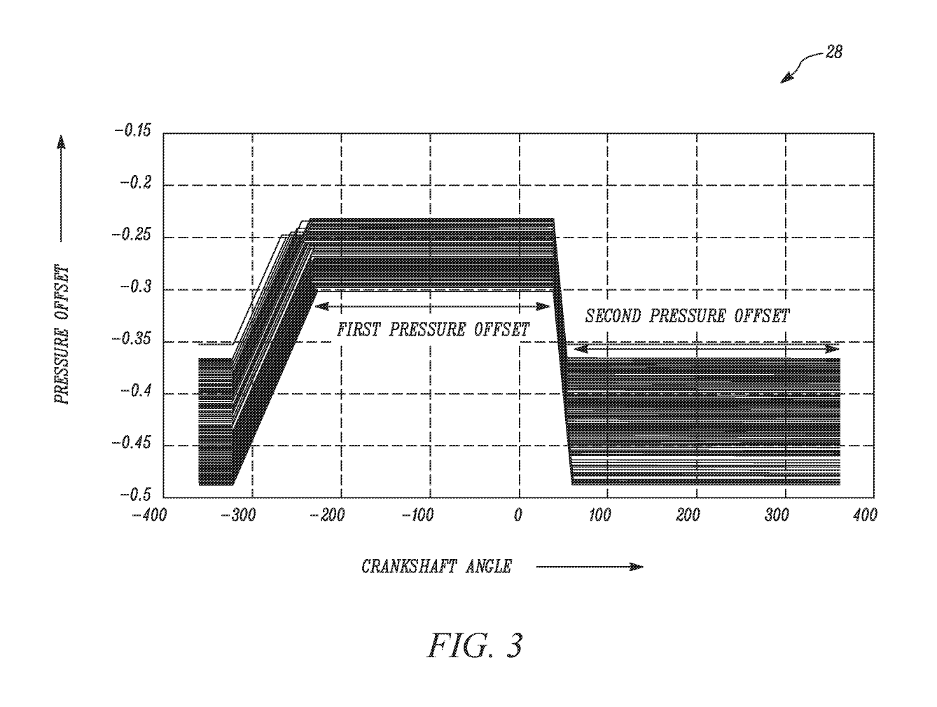

Referring to FIG. 3, a graph 28 showing working of the controller 24 to shift between the first pressure offset and the second pressure offset based on the stroke of the engine 10 is illustrated. More specifically, FIG. 3 is an exemplary graph 28 showing a plot of pressure offset against crankshaft angle. The graph 28 represents change in pressure offset values based on varying crankshaft angles. In other embodiments, the graph 28 may represent change in the pressure offset values based on varying camshaft angles based on application requirements.

During the compression stroke, the controller 24 is configured to determine the corrected pressure value using the first pressure offset approximately between (−250) degrees and (+40) degrees of the crankshaft angle. Also, during the expansion stroke, the controller 24 is configured to determine the corrected pressure value using the second pressure offset approximately between (+60) degrees and (−310) degrees of the crankshaft angle. The controller 24 is configured to transition from the first pressure offset to the second pressure offset approximately between (+40) degrees and (+60) degrees of the crankshaft angle and will be explained in more detail.

The controller 24 is also configured to transition from the second pressure offset to the first pressure offset approximately between (−310) degrees and (−250) degrees of the crankshaft angle and will be explained in more detail. It should be noted that a magnitude of the first pressure offset and the second pressure offset illustrated herein is merely exemplary. In the illustrated embodiment, the first pressure offset includes a larger magnitude with respect to the second pressure offset. In other embodiments, the first pressure offset may include a smaller magnitude with respect to the second pressure offset based on application requirements. Also, each of the first pressure offset and the second pressure offset may be either positive or negative.

It should be noted that the crankshaft/camshaft angles during which the controller 24 may use the first pressure offset, the second pressure offset, and/or may transition between the first pressure offset and the second pressure offset disclosed herein is merely exemplary. In other embodiments, the controller 24 may use the first pressure offset. the second pressure offset, and/or may transition between the first pressure offset and the second pressure offset during any position of the crankshaft/camshaft based on application requirements and may not limit the scope of the disclosure. Also, the graph 28 disclosed herein employs a simple ramp strategy to transition between the first pressure offset and the second pressure offset, In other embodiments, the controller 24 may employ other transition strategies such as a constantly decreasing step strategy, an exponentially decaying step strategy, and so on, based on application requirements without limiting the scope of the disclosure.

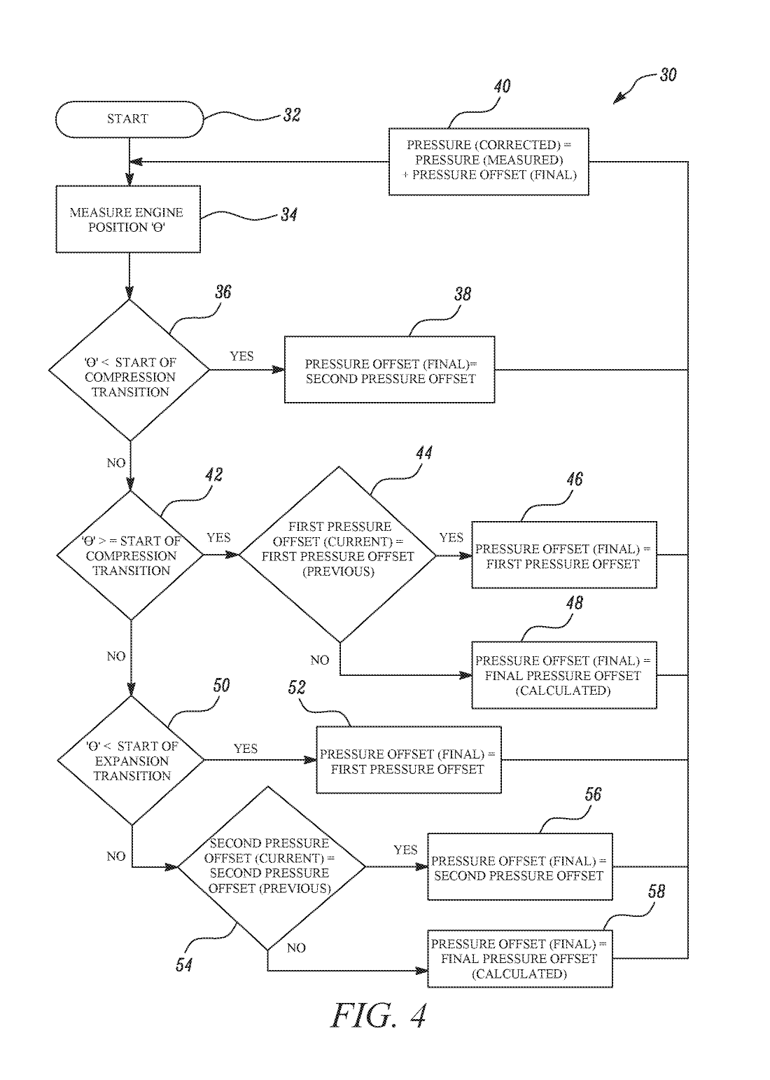

Referring to FIG. 4, a method 30 of working of the controller 24 is illustrated. At step 32, the controller 24 is configured to start a process to determine the pressure offset. At step 34, the controller 24 is configured to determine an engine position ‘0’. The engine position ‘0’ may be the angular position of the crankshaft/camshaft or the position of the piston. At step 36, the controller 24 is configured to determine if the engine position ‘0’ is before start of compression transition. The compression transition is indicative of end of an intake stroke and start of the compression stroke of the engine 10. In the illustrated embodiment, the compression transition of the engine 10 may represent approximately between (−310) degrees and (−250) degrees of the crankshaft angle.

If the condition at step 36 is true, the controller 24 is configured to proceed to step 38. At step 38, the controller 24 is configured to determine a final pressure offset as the second pressure offset, Further, the controller 24 is configured to proceed to step 40. At step 40, the controller 24 determines the corrected pressure value based on a measured pressure value by the pressure sensor 20 and the final pressure offset (the second pressure offset in this case). More specifically, the corrected pressure value is an addition of the measured pressure value and the final pressure offset.

If the condition at step 36 is false, the controller 24 is configured to proceed to step 42. At step 42, the controller 24 is configured to determine if the engine position ‘0’ is at the compression transition. If the condition at step 42 is true, the controller 24 is configured to proceed to step 44. At step 44, the controller 24 is configured to determine if the first pressure offset of a current engine cycle is approximately equal to a first pressure offset of a previous engine cycle.

If the condition at step 44 is true, the controller 24 is configured to proceed to step 46. At step 46, the controller 24 determines the final pressure offset as the first pressure offset. Further, the controller 24 is configured to proceed to step 40 to determine the corrected pressure value. At step 40, the controller 24 determines the corrected pressure value based on the measured pressure value by the pressure sensor 20 and the final pressure offset (the first pressure offset in this case).

If the condition at step 44 is false, the controller 24 is configured to proceed to step 48. At step 48, the controller 24 determines a calculated final pressure offset based on engine parameters including, but not limited to, engine position ‘0’, engine speed, and the first pressure offset of the previous engine cycle. Further, the controller 24 is configured to proceed to step 40 to determine the corrected pressure value. At step 40, the controller 24 determines the corrected pressure value based on the measured pressure value by the pressure sensor 20 and the final pressure offset (the calculated final pressure offset in this case).

If the condition at step 42 is false, the controller 24 is configured to proceed to step 50. At step 50, the controller 24 is configured to determine if the engine position ‘0’ is before start of expansion transition. The expansion transition is indicative of end of the compression stroke and start of the expansion stroke of the engine. In the illustrated embodiment, the expansion transition of the engine 10 may represent approximately between (+40) degrees and (+60) degrees of the crankshaft angle.

If the condition at step 50 is true, the controller 24 is configured to proceed to step 52. At step 52, the controller 24 is configured to determine the final pressure offset as the first pressure offset. Further, the controller 24 is configured to proceed to step 40. At step 40, the controller 24 determines the corrected pressure value based on the measured pressure value by the pressure sensor 20 and the final pressure offset (the first pressure offset in this case)

If the condition at step 50 is false, the controller 24 is configured to proceed to step 54. At step 54, the controller 24 is configured to determine if the second pressure offset of a current engine cycle is approximately equal to a second pressure offset of a previous engine cycle. If the condition at step 54 is true, the controller 24 is configured to proceed to step 56. At step 56, the controller 24 determines the final pressure offset as the second pressure offset. Further, the controller 24 is configured to proceed to step 40 to determine the corrected pressure value. At step 40, the controller 24 determines the corrected pressure value based on the measured pressure value by the pressure sensor 20 and the final pressure offset (the second pressure offset in this case).

If the condition at step 54 is false, the controller 24 is configured to proceed to step 58. At step 58, the controller 24 determines a calculated final pressure offset based on engine parameters including, but not limited to, engine position ‘0’, engine speed, and the second pressure offset of the previous engine cycle. Further, the controller 24 is configured to proceed to step 40 to determine the corrected pressure value. At step 40, the controller 24 determines the corrected pressure value based on the measured pressure value by the pressure sensor 20 and the final pressure offset (the calculated final pressure offset in this case).

### INDUSTRIAL APPLICABILITY

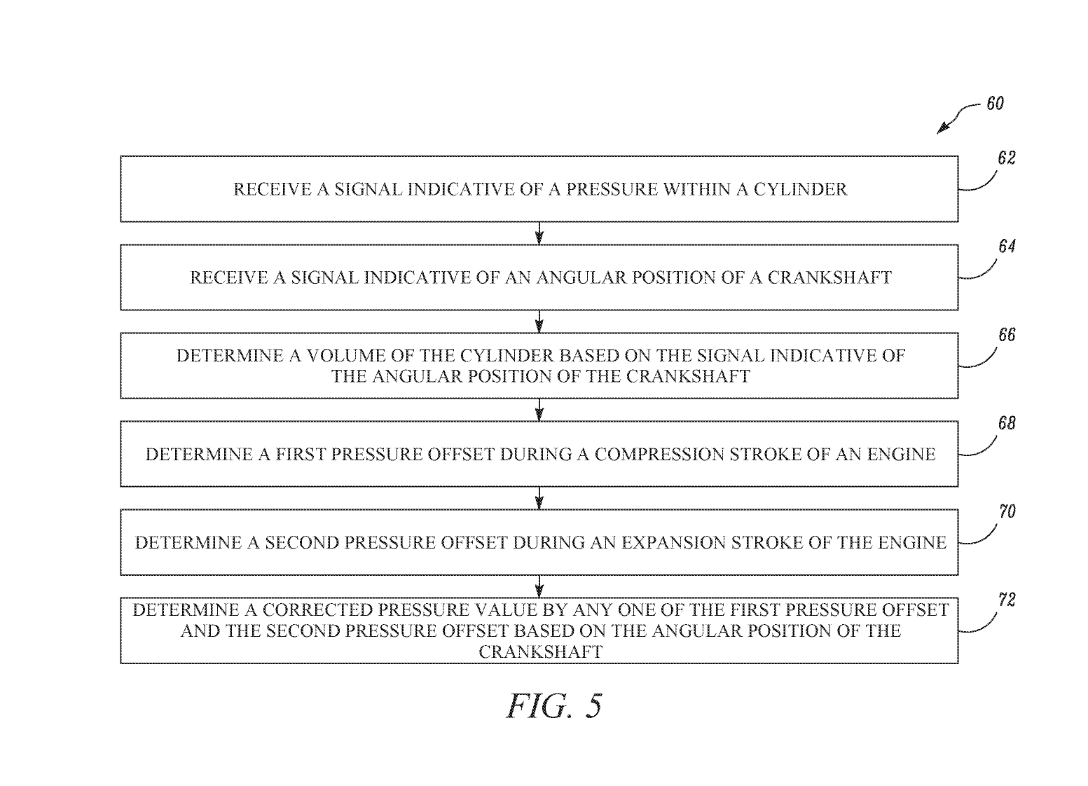

The present disclosure relates to the pressure measurement system 18. Referring to FIG. 5, a method 60 of working of the pressure measurement system 18 is illustrated. At step 62, the controller 24 receives the signal indicative of the pressure within the cylinder of the engine 10 from the pressure sensor 20. At step 64, the controller 24 receives the signal indicative of the angular position of the crankshaft from the angle sensor 22. At step 66, the controller 24 determines the volume of the cylinder based on the signal indicative of the angular position of the crankshaft.

More specifically, the controller 24 determines the first volume V1 of the cylinder when the pressure within the cylinder is the first pressure P1. The controller 24 determines the second volume V2 of the cylinder when the pressure within the cylinder is the second pressure P2. The controller 24 also determines the third volume V3 of the cylinder when the pressure within the cylinder is the third pressure P3. The controller 24 further determines the fourth volume V4 of the cylinder when the pressure within the cylinder is the fourth pressure P4.

At step 68, the controller 24 determines the first pressure offset during the compression stroke of the engine 10. More specifically, the controller 24 determines the first pressure offset based on the first pressure P1, the first volume V1, the second pressure P2, and the second volume V2.

At step 70, the controller 24 determines the second pressure offset during the expansion stroke of the engine 10. More specifically, the controller 24 determines the second pressure offset based on the third pressure P3, the third volume V3, the fourth pressure P4, and the fourth volume V4.

At step 72, the controller 24 determines the corrected pressure value by any one of the first pressure offset and the second pressure offset based on the angular position of the crankshaft. More specifically, the controller 24 determines the corrected pressure value using the first pressure offset during the compression stroke of the engine 10. Also, the controller 24 determines the corrected pressure value using the second pressure offset during the expansion stroke of the engine 10.

The pressure measurement system 18 provides a simple, efficient, and accurate method to determine the pressure offset and the corrected pressure value due to the thermal shock experienced by the pressure sensor 20 during different strokes of the engine 10. The pressure measurement system 18 provides correction of pressure measurement regardless of the type of the pressure sensor 20 used including ones that may or may not provide an absolute pressure value. Also, the corrected pressure measurement may be applicable to all engine parameter calculations including, but not limited to, peak pressure, indicated mean effective pressure, heat release, in-cylinder temperature estimation, and so on. The pressure measurement system 18 may be employed in any engine 10 with minor or no modification to the existing system. Further, the pressure measurement system 18 may determine the pressure offset and the corrected pressure value using existing components of the engine 10 such as the pressure sensor 20, the angle sensor 22, and the controller 24.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of the disclosure. Such embodiments should be understood to fall within the scope of the present disclosure as determined based upon the claims and any equivalents thereof.

What is claimed is:

1. A pressure measurement system for an engine, the pressure measurement system comprising:
a pressure sensor coupled to a cylinder of the engine, the pressure sensor configured to generate a signal indicative of a pressure within the cylinder;
an angle sensor coupled to a crankshaft of the engine, the angle sensor configured to generate a signal indicative of an angular position of the crankshaft of the engine;
a controller coupled to the pressure sensor and the angle sensor, the controller configured to:
receive the signal indicative of the pressure within the cylinder;
receive the signal indicative of the angular position of the crankshaft:
determine a volume of the cylinder based on the signal indicative of the angular position of the crankshaft;
determine a first pressure offset during a compression stroke of the engine;
determine a second pressure offset during an expansion stroke of the engine;
determine a corrected pressure value by any one of the first pressure offset and the second pressure offset based on the angular position of the crankshaft.
